(19) United States
(12) Patent Application Publication
(10) Pub. No.: US 2011/0186639 A1
(43) Pub. Date: Aug. 4, 2011

(54) CONTACT APERTURE FOR IMAGING APPARATUS

(75) Inventor: Sean Philip Kearney, Marlton, NJ (US)

(73) Assignee: Metrologic Instruments, Inc., Blackwood, NJ (US)

(21) Appl. No.: 12/699,932

(22) Filed: Feb. 4, 2010

(51) Int. Cl. G06K 7/10; B05D 5/06

(52) U.S. Cl. 235/472.01; 235/454; 427/162

(57) ABSTRACT

Disclosed is an optical imaging apparatus for focusing an image of an encoded symbol character onto an image sensor. The optical imaging apparatus includes a housing having a user input interface and a user output interface. An imaging module disposed within the housing is adapted to receive a cone of bundled light rays reflected from the encoded symbol character. The image sensor has a multiple pixel image sensor array disposed on a printed circuit board. The optical imaging apparatus further includes a focus element disposed within the imaging module, wherein the focus element is adapted to form and project the encoded symbol character upon the image sensor. A lens holding assembly is disposed within the focus element, and includes a barrel housing having a distal end for receiving the cone of bundled light rays and a proximal end for projecting an apertured cone of bundled light rays onto the image sensor. An optical lens element is disposed within an interior bore of the barrel housing. The optical lens element has a first lens surface and an opposing second lens surface; the first lens surface has a clear region and an opaque region. The opaque region is formed by a contact aperture disposed on the first lens surface, wherein the contact aperture is adapted to modify a cone angle of the bundle of light rays projected on the image sensor.

### FIELD OF THE INVENTION

This disclosure relates generally to an optical lens element for incorporation into an optical imaging system, and specifically to an apparatus and method comprising a contact aperture disposed on the lens element.

### BACKGROUND OF THE INVENTION

Various optical imaging systems have been developed to read and decode optical indicia, such as bar code symbols on a target such as a label. Well-known among the varieties is the gun style terminal as commonly seen at retail store checkout counters. Other terminals are also available that provide enhanced functions, have keyboards, and displays, and include advanced networking communication capabilities. One common design among the gun style terminals includes an imaging module to receive a reflected cone of bundled light rays from illuminated optical indicia such as encoded symbol characters. The imaging module includes a focus element having a lens holding assembly. In one example construction, the lens holding assembly includes an elongated barrel-shaped housing having a plurality of optical lens elements. Disposed between two of the optical lens elements is an aperture element to determine the cone angle of the bundled light rays that come to a focus onto an image sensor.

### SUMMARY OF THE INVENTION

Disclosed is an optical imaging apparatus for focusing an image of an encoded symbol character onto an image sensor. The optical imaging apparatus includes a housing having a user input interface and a user output interface. An imaging module disposed within the housing is adapted to receive a cone of bundled light rays reflected from the encoded symbol character. The image sensor has a multiple pixel image sensor array disposed on a printed circuit board. The optical imaging apparatus further includes a focus element disposed within the imaging module, wherein the focus element is adapted to form and project the encoded symbol character upon the image sensor. A lens holding assembly is disposed within the focus element, and includes a barrel housing having a distal end for receiving the cone of bundled light rays and a proximal end for projecting an apertured cone of bundled light rays onto the image sensor. An optical lens element is disposed within an interior bore of the barrel housing. The optical lens element has a first lens surface and an opposing second lens surface; the first lens surface has a clear region and an opaque region. The opaque region is formed by a contact aperture disposed on the first lens surface, wherein the contact aperture is adapted to modify a cone angle of the bundle of light rays projected on the image sensor.

In one aspect of the invention, the contact aperture is applied directly to the first lens surface.

In one example, the contact aperture comprises a thin film coating.

In another aspect of the invention, a method for focusing an image of encoded symbol characters onto an image sensor is disclosed. The method includes the step of providing an optical imaging apparatus that includes a housing and an imaging module disposed within the housing. The imaging module includes the image sensor and a lens holding assembly. The method further includes the steps of illuminating the encoded symbol characters and focusing a cone of bundled rays reflected from the encoded symbol characters through an optical lens element onto the image sensor, wherein the optical lens element is disposed within the lens holding assembly. The method further includes the steps of modifying a cone angle of the bundled rays projected on the image sensor by applying a contact aperture directly to lens surface of the optical lens element.

In a further aspect of the invention, the step of applying a contact aperture includes the steps of applying a mask to a portion of the optical lens element, coating the lens element with an opaque material, and removing the mask.

### BRIEF DESCRIPTION OF THE DRAWINGS

For a further understanding of the invention, reference will be made to the following detailed description of the invention which is to be read in connection with the accompanying drawing, wherein:

FIG. 1 is a perspective view of an optical imaging apparatus according to one embodiment of the present invention;

FIG. 2 is an exploded perspective view of the imaging module of FIG. 1;

FIG. 3 is an exploded perspective view of the focus element of FIG. 2;

FIG. 4 is a cross-sectional schematic view of the lens holding assembly shown in FIG. 3;

FIG. 5A is a cross-sectional schematic view of a prior art aperture element;

FIG. 5B is an exploded perspective view of another prior art aperture element;

FIG. 5C is a cross-sectional schematic view of yet another prior art aperture element;

FIG. 6A-6C are perspective views of optical lens elements with contact apertures according to three embodiments of the present invention; and

FIG. 7 is a block diagram of an exemplary hardware platform for implementation in optical imaging apparatus such as the indicia reading terminal of FIG. 1.

### DETAILED DESCRIPTION OF THE INVENTION

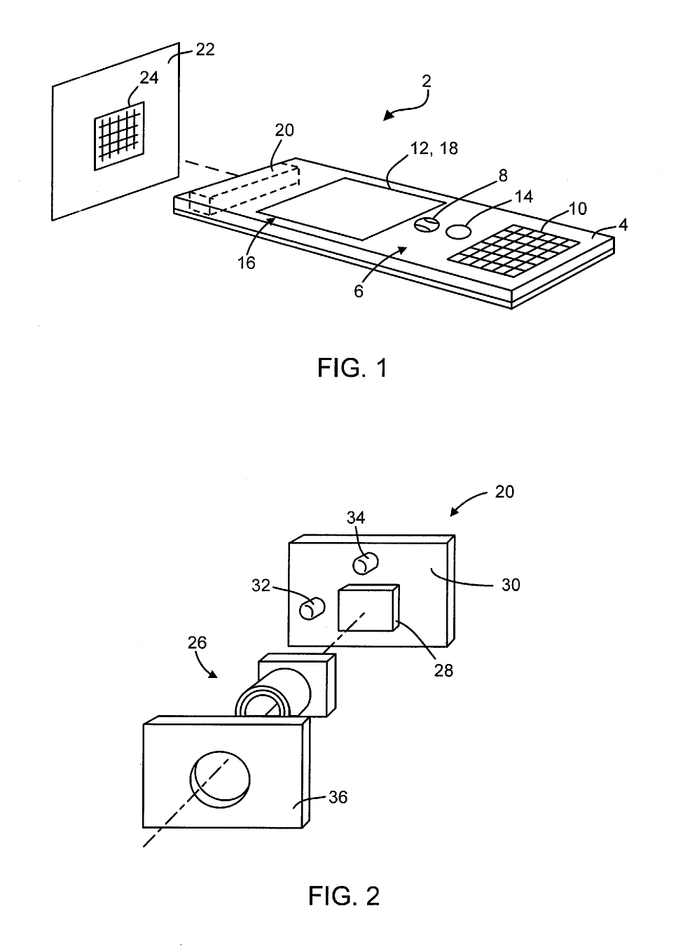

Referring to FIG. 1, an optical imaging apparatus 2 may include a hand held housing 4 that supports a user input interface 6 with a pointer controller 8, a keyboard 10, a touch panel 12, and a trigger 14. The hand held housing 4 may also support a user output interface 16 with a display 18. The optical imaging apparatus 2 further includes an imaging module 20 adapted to receive light rays reflected from a target 22 having encoded symbol characters 24 of a symbology, for example bar codes. The imaging module 20, shown in detail in FIG. 2, includes a focus element 26 and an image sensor 28 that is disposed on a printed circuit board 30 together with an illumination pattern illumination light source bank 32 and aiming pattern light source bank 34. In the illustrated example, each of the illumination light source bank 32 and the aiming pattern light source bank 34 is provided as a single light source. The imaging module 20 may also include an optical plate 36 that has optics for shaping light from the illumination bank 32, and the aiming bank 34 into predetermined patterns.

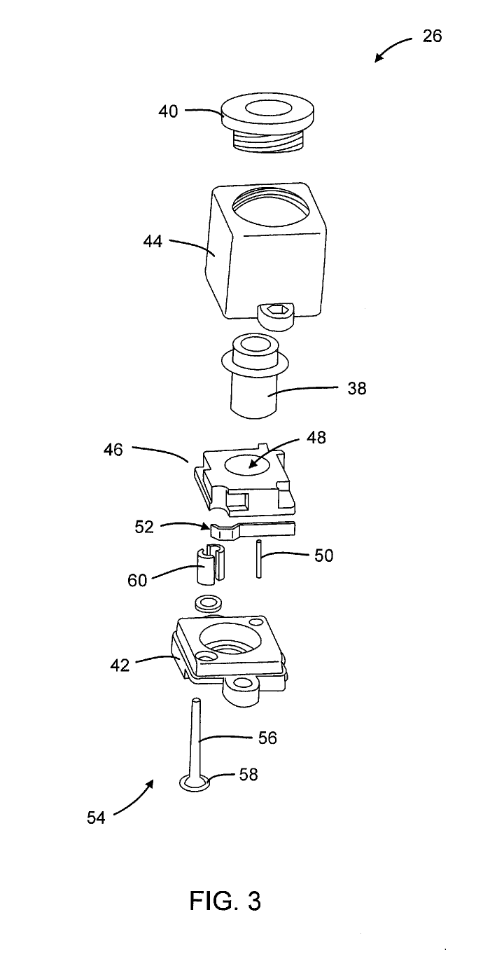

Turning now to FIG. 3, the focus element 26 includes a lens holding assembly 38, a fixed lens element 40, a base element 42, and a housing element 44. In the disclosed embodiment, the lens holding assembly 38 is a variable position lens holder adapted for use with a moveable lens system. The focus element 26 also includes a moveable platform 46 with a central opening 48, a guide pin 50, a support spring 52, as well as an actuator assembly 54 that interacts with at least the moveable platform 46 so as to induce relative movement between the lens holding assembly 38 and the fixed lens element 40.

The actuator assembly 54 may include a drive shaft 56, an actuator 58, and a coupling device 60 such as a pair of friction pads that couples the drive shaft 56 to the moveable platform 46. Actuator 58 may be selected so as to provide movement of, e.g., the moveable platform 46 in finite and acutely measured increments such as those increments generally associated with stepper motors, and more particularly with piezoelectric actuators. For example, piezoelectric actuators that can be used in one embodiment of the focus element 26 can have step increments that are less than about 15 μm, and more particularly the step increments are from about 5 μm to about 50 μm. Such step increments can be provided by linear and rotary actuators that are arranged in a manner that transmits motive forces from the actuator 58 to the movable platform 46 through the drive shaft 56. These include, for example, piezoelectric actuators to generate linear and/or rotational motion, as well as piezoelectric actuators with direct drive mechanisms, e.g., “squiggle motors.” Examples of at least one linear piezoelectric actuator that can be incorporated into focus element 26 include a model number TULA35, available from Piezoelectric Technology Co., Ltd., of Seoul, South Korea. Moreover, details of the function, construction, and operation of piezoelectric actuators are generally recognized by those having ordinary skill in the art, and therefore a detailed description of these aspects of the piezoelectric actuators are not provided unless necessary to explain certain concepts of the present invention.

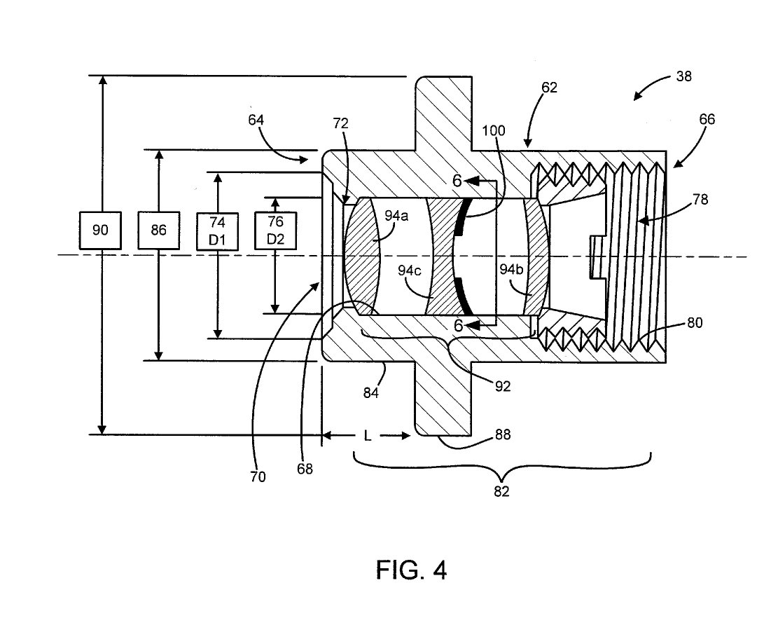

Referring to FIG. 4, the lens holding assembly 38 includes a generally elongated barrel housing 62 with a distal end 64, a proximal end 66, and an interior bore 68 that extends therebetween. On the distal end 64, the interior bore 68 can comprise a distal opening 70 with a stepped portion 72, and by way of non-limiting example the stepped portion 72 may have a first diameter portion 74 with a first interior diameter D1, and a second diameter portion 76 with a second interior diameter D2, wherein the second diameter D2 is less than the first diameter D1. On the proximal end 66, the interior bore 68 may include a proximal opening 78, and an interior threaded portion 80. The interior bore 68 may also include a lens assembly region 82 that may extend between the second diameter portion 76 and the interior threaded portion 80.

The elongated barrel housing 62 may also include an outer barrel surface 84 with an outer barrel dimension 86, and a shoulder 88 that may be located a distance L from the distal end 64. The shoulder 88 may have an outer shoulder dimension 90. The lens holding assembly 38 further includes an image formation optics assembly 92 that may be positioned inside of the lens assembly region 82. The image formation optics assembly 92 may include a number of optical lens elements 94 depending on the solution space required by the design. For example, in the disclosed embodiment the image formation optics assembly 92 includes a Cooke triplet lens having a first optical lens element 94a near the distal end 64. In the disclosed example, the first optical lens element 94a is a biconvex lens. The image formation optics assembly 92 further includes a second optical lens element 94b near the proximal end 66 that is a positive meniscus lens having a concavity and an optical power. A third optical lens element 94c positioned between the first optical lens element 94a and the second optical lens element 94b is a biconcave lens. Together, the illustrated image formation optics assembly 92 provides six lens curvatures, three different thicknesses, and three different lens materials thereby affording optical system designers great flexibility in designing an optimal design.

As mentioned above, the image formation optics assembly 92, and more particularly the optical lens elements 94 may be constructed of a variety of materials, using a variety of techniques. Each of the optical lens elements 94 may be formed monolithically, for example as a singular lens elements constructed of glass, polycarbonate, or other materials fabricated to appropriate prescriptions for the task at hand, and that can provide an optically clear path therethrough. In other examples, the optical lens elements 94 may be constructed as individual assemblies, each with multiple optical membranes, outer supportive features that hold the membranes together, as well as other materials, e.g., focus fluids. Still other examples of the image formation optics assembly 92 may have additional structures and pieces that support, align, space, and/or position the optical lens elements 94 relative to one another, relative to the other pieces of the lens holding assembly 38, as well as relative to other parts, e.g., the fixed lens element 40 (FIG. 3) when these parts are assembled together as in an indicia reading terminal device.

The elongated barrel housing 62 may be constructed of generally recognized materials that are compatible with the concepts disclosed and described herein. Exemplary materials may include metals (e.g., brass), plastics (e.g., polycarbonate), as well as composites, compositions, and combinations of the same. Differences and selection of the material may be based on the manufacturing techniques that are required such as those manufacturing techniques that provide for lower costs of construction, manufacture, etc. Although not necessarily depicted in the example of FIG. 4, or in other examples that are illustrated in the drawings, fasteners and adhesives may be used to secure the various parts of the assembly to other parts of the assembly, such as, for example, for securing the optical lens elements 94a, 94b, and/or 94c (and/or image formation optics assembly 92) in position within the barrel housing 62.

In the illustrated example, the image formation optics assembly 92 comprises a triplet. While the construction of these components may vary, the image formation optics assembly 92 in certain implementations may be constructed as a singlet, a doublet, or any number of lens elements without departing from the scope of the invention disclosed herein.

Further, in another embodiment, the fixed lens element 40 may be replaced by a variable focus lens assembly (not shown) to extend the working range of the optical imaging apparatus 2. For example, the variable focus lens assembly may be an electro-wetting lens assembly, wherein the curvature of the lens is varied depending on an applied voltage. In another example, the variable focus lens assembly may comprise an actuator adapted to impart a force to a deformable lens surface.

In yet another embodiment, the lens holding assembly 38 may be a fixed lens element.

Prior art lens assemblies within an imaging module typically include an aperture element disposed between two of the lens elements. The aperture element of an optical imaging system determines the cone angle of a bundle of rays that come to a focus onto the image plane. The aperture element determines the degree of collimation for the admitted rays, which is of great importance for the appearance at the image plane. As the admitted rays pass through the lens, highly collimated rays (e.g., a narrow aperture) will result in sharpness at the image plane, while uncollimated rays (e.g., a wide aperture) will result in sharpness for rays with the right focal length only. The aperture element also determines how many of the incoming light rays are actually admitted and thus how much light reaches the image plane (the narrower the aperture, the darker the image). Thus, the aperture element determines the ray cone angle, or equivalently the brightness, at an image point.

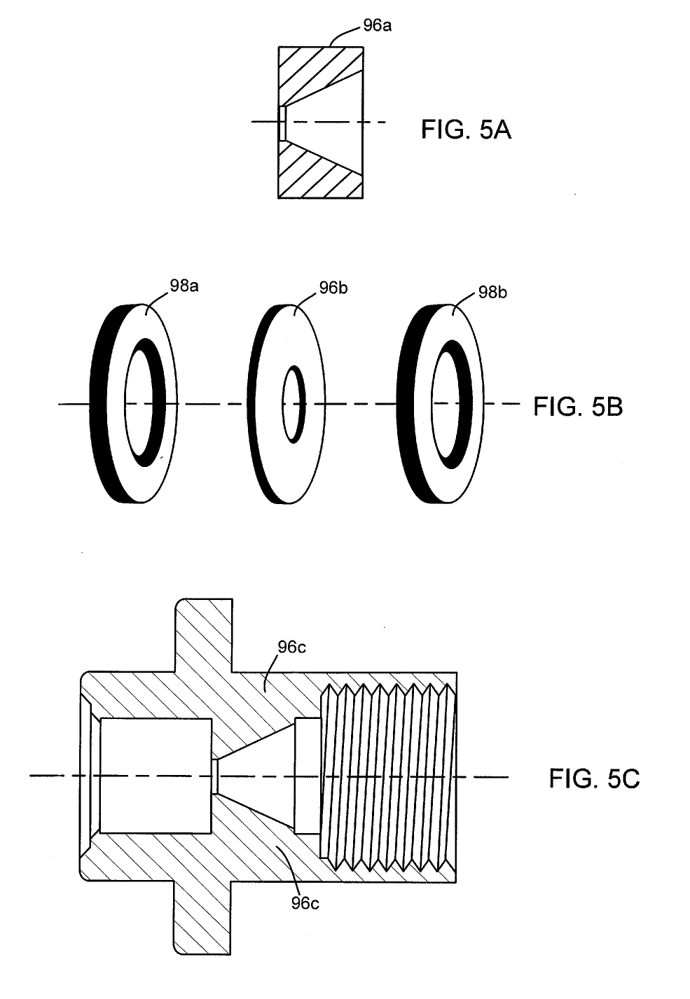

One example of a prior art aperture element is illustrated in FIG. 5. Shown as 96a, the aperture element is a separate structure disposed within the inner bore of the barrel. In one implementation, the aperture element 96a is disposed between the second and third lens element of a triplet lens assembly. In another example, the aperture element 96b is a thin disc requiring one or more spacers 98a, 98b on either side of the aperture element to properly position the aperture element within the inner bore of the barrel. In yet another example, the aperture element 96c may be machined integral within the inner bore of the barrel.

Although these prior art aperture elements can be useful and may be advantageous for certain applications, they suffer from drawbacks. One noted problem with prior art aperture elements 96 is that they are prone to misalignment, causing changes to the circularity of the lens assembly. For example, the aperture element depicted as 96a, as well as the mating inner bore of the barrel, must be machined to precision tolerances in order to precisely align with the lens elements. Parallelism, concentricity, and diametric tolerances must be held very tight. Additionally, the finish on the aperture element 96 must be carefully controlled to prevent burrs and the like from obstructing the path of light rays.

A drawback to the aperture element depicted as 96b (e.g., the thin disc) is that the disc is prone to de-centering and tilting within the inner bore of the barrel, which may manifest itself as image contrast shifts or image blur. The spacers 98 help reduce the likelihood of these occurrences, but adding parts to the system further contributes to problems associated with tolerance stack-ups and circularity. A drawback to the aperture element depicted as 96c (e.g., integral aperture within barrel) is the additional cost of machining the inner bore with tightly-toleranced steps and cone angles.

In summary, every deviation from the intended design of the lens system, no matter how small, causes some aberration. This principal also applies to the constraints of the design of the aperture element—the aperture is assumed infinitely thin for design/modeling purposes, yet in reality the aperture element may be quite thick. Thus, some deviation from the intended design is introduced simply due to the thickness of the aperture element.

Referring back to FIG. 4, in an effort to alleviate these problems, a contact aperture 100 is applied directly to a surface of at least one optical lens element 94 to shape the cone of bundled rays that is projected on the image sensor 28 (FIG. 1), thereby eliminating the aperture element of the prior art. The contact aperture 100 is an opaque material, such as black paint, that will absorb light bundles passing through the interior bore 68 of the lens holding assembly 38. Only light passing through the clear portion of the optical lens element 94 is projected on the image sensor 28 (FIG. 1) and peripheral divergent light is absorbed by the contact aperture 100. The contact aperture 100 may be applied to any of the lenses, on either side.

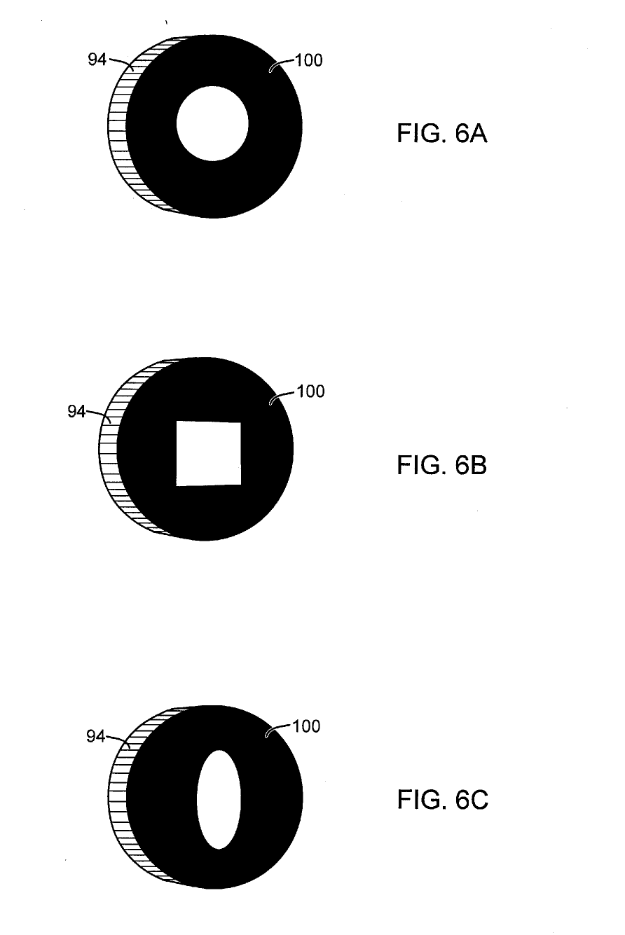

Referring to FIG. 6, the contact aperture 100 may be formed by applying a mask or stencil to a central portion of the optical lens element 94, coating the lens element with the opaque contact aperture 100, and then removing the mask or stencil. The mask may be a variety of shapes depending on the particular needs of the application. For example, the mask (and resulting clear area) may be circular (FIG. 6A), a square (FIG. 6B), or elliptical (FIG. 6C). Alternately, the contact aperture 100 may be formed directly on the lens surface by vapor deposition or thin film coating.

Referring now back to FIG. 1, exemplary devices that can be used for devices of the user input interface 6 are generally discussed below. Each of these is implemented as part of, and often integrated into the hand held housing 4 so as to permit an operator to input one or more operator initiated commands. These commands may specify, and/or activate certain functions of the indicia reading terminal. They may also initiate certain ones of the applications, drivers, and other executable instructions so as to cause the optical imaging apparatus 2 to operate in an operating mode.

Devices that are used for the pointer controller 8 are generally configured so as to translate the operator initiated command into motion of a virtual pointer provided by a graphical user interface (“GUI”) of the operating system of the optical imaging apparatus 2. It can include devices such as a thumbwheel, a roller ball, and a touch pad. In some other configurations, the devices may also include a mouse, or other auxiliary device that is connected, e.g., via wire, or wireless communication technology, to the optical imaging apparatus 2.

Implementation of the keyboard 10 can be provided using one or more buttons, which are presented to the operator on the hand held housing 4. The touch panel 12 may supplement, or replace the buttons of the keyboard 10. For example, one of the GUIs of the operating system may be configured to provide one or more virtual icons for display on, e.g., the display 18, or as part of another display device on, or connected to the optical imaging apparatus 2. Such virtual icons (e.g., buttons, and slide bars) are configured so that the operator can select them, e.g., by pressing or selecting the virtual icon with a stylus (not shown) or a finger (not shown).

The virtual icons can also be used to implement the trigger 14. On the other hand, other devices for use as the trigger 14 may be supported within, or as part of the hand held housing 4. These include, but are not limited to, a button, a switch, or a similar type of actionable hardware that can be incorporated into the embodiments of the optical imaging apparatus 2. These can be used to activate one or more of the devices of the portable data terminal, such as the bar code reader discussed below.

Displays of the type suited for use on the optical imaging apparatus 2 are generally configured to display images, data, and GUIs associated with the operating system and/or software (and related applications) of the optical imaging apparatus 2. The displays can include, but are not limited to, LCD displays, plasma displays, LED displays, among many others and combinations thereof. Although preferred construction of the portable optical imaging apparatus 2 will include devices that display data (e.g., images, and text) in color, the display that is selected for the display 18 may also display this data in monochrome (e.g., black and white). It may also be desirable that the display 18 is configured to display the GUI, and in particular configurations of the optical imaging apparatus 2 that display 18 may have an associated interactive overlay, like a touch screen overlay. This permits the display 18 to be used as part the GUI so as to permit the operator to interact with the virtual icons, the buttons, and other implements of the GUI to initiate the operator initiated commands, e.g., by pressing on the display 18 with the stylus (not shown) or finger (not shown).

The hand held housing 4 can be constructed so that it has a form, or “form factor” that can accommodate some, or all of the hardware and devices mentioned above, and discussed below. The form factor defines the overall configuration of the hand held housing 4. Suitable form factors that can be used for the hand held housing 4 include, but are not limited to, cell phones, mobile telephones, personal digital assistants (“PDA”), as well as other form factors that are sized and shaped to be held, cradled, and supported by the operator, e.g., in the operator's hand(s) as a gun-shaped device. One exemplary form factor is illustrated in the embodiment of the optical imaging apparatus 2 that is illustrated in the present FIG. 1.

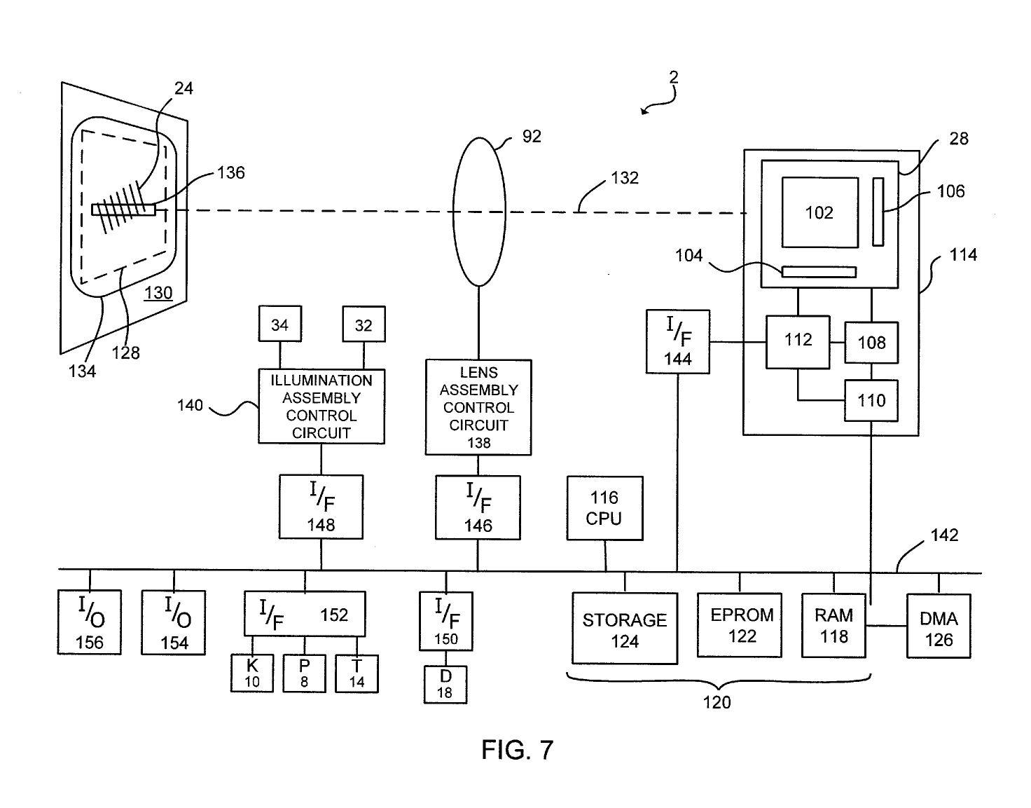

An exemplary hardware platform for use in, e.g., the optical imaging apparatus 2 is illustrated and described with reference to the schematic, block diagram of FIG. 7. In FIG. 7, it is seen that an optical imaging apparatus 2 can include an image sensor 28 comprising a multiple pixel image sensor array 102 having pixels arranged in rows and columns of pixels, associated column circuitry 104 and row circuitry 106. Associated with the image sensor 28 can be amplifier circuitry 108, and an analog to digital converter 110 which converts image information in the form of analog signals read out of image sensor array 102 into image information in the form of digital signals. Image sensor 28 can also have an associated timing and control circuit 112 for use in controlling, e.g., the exposure period of image sensor 28, and/or gain applied to the amplifier circuitry 108. The noted circuit components 28, 108, 110, and 112 can be packaged into a common image sensor integrated circuit 114. In one example, image sensor integrated circuit 114 can be provided by an MT10V022 image sensor integrated circuit available from Micron Technology, Inc. In another example, image sensor integrated circuit 114 can incorporate a Bayer pattern filter. In such an embodiment, a CPU 116 prior to subjecting a frame to further processing can interpolate pixel values intermediate of green pixel values for development of a monochrome frame of image data. In other embodiments, red, and/or blue pixel values can be utilized for the image data.

In the course of operation of apparatus 2 image signals can be read out of image sensor 28, converted and stored into a system memory such as RAM 118. A memory 120 of optical imaging apparatus 2 can include RAM 118, a nonvolatile memory such as EPROM 122, and a storage memory device 124 such as may be provided by a flash memory or a hard drive memory. In one embodiment, the optical imaging apparatus 2 can include CPU 116 which can be adapted to read out image data stored in memory 120 and subject such image data to various image processing algorithms. Optical imaging apparatus 2 can include a direct memory access unit (DMA) 126 for routing image information read out from image sensor 28 that has been subject to conversion to RAM 118. In another embodiment, imaging apparatus 2 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor 28 and RAM 118 are within the scope and the spirit of the invention.

Referring to further aspects of imaging apparatus 2, imaging apparatus 2 includes the image formation optics assembly 92 for focusing an image of the decodable indicia 24 located within a field of view 128 on a substrate 130 onto image sensor 28. Imaging light rays can be transmitted about an optical axis 132. Optics assembly 92 can be adapted to be capable of multiple focal lengths and/or multiple best focus distances.

Imaging apparatus 2 can also include the illumination pattern light source bank 32 for generating an illumination pattern 134 substantially corresponding to the field of view 128 of imaging apparatus 2, and an aiming pattern light source bank 34 for generating an aiming pattern 136 on substrate 130. In use, imaging apparatus 2 can be oriented by an operator with respect to the substrate 130 bearing decodable indicia 24 in such manner that aiming pattern 136 is projected on a decodable indicia 24. In the example of FIG. 7, the decodable indicia 24 are provided by a 1D bar code symbol. Decodable indicia could also be provided by 2D bar code symbols or optical character recognition (OCR) characters.

Each of illumination pattern light source bank 32 and aiming pattern light source bank 34 can include one or more light sources. Optics assembly 92 can be controlled with use of a lens assembly control circuit 138 and the illumination assembly comprising illumination pattern light source bank 32 and aiming pattern light source bank 34 can be controlled with use of illumination assembly control circuit 140. Lens assembly control circuit 138 can send signals to the optics assembly 92, e.g., for changing a focal length and/or a best focus distance of the optics assembly. This can include for example providing a signal to the piezoelectric actuator to change the position of the variable position element of the focus element discussed above. Illumination assembly control circuit 140 can send signals to illumination pattern light source bank 32, e.g., for changing a level of illumination output by illumination pattern light source bank.

Imaging apparatus 2 can also include a number of peripheral devices such as display 18 for displaying such information as image frames captured with use of imaging apparatus 2, keyboard 10, pointing device 8, and trigger 14 which may be used to make active signals for activating frame readout and/or certain decoding processes. Imaging apparatus 2 can be adapted so that activation of trigger 14 activates one such signal and initiates a decode attempt of the decodable indicia 24.

Imaging apparatus 2 can include various interface circuits for coupling several of the peripheral devices to system address/data bus (system bus) 142, for communication with CPU 116 also coupled to system bus 142. Imaging apparatus 2 can include a first interface circuit 144 for coupling image sensor timing and control circuit 112 to system bus 142, a second interface circuit 146 for coupling lens assembly control circuit 138 to system bus 142, a third interface circuit 148 for coupling illumination assembly control circuit 140 to system bus 142, a fourth interface circuit 150 for coupling display 18 to system bus 142, and a fifth interface circuit 152 for coupling keyboard 10, pointing device 8, and trigger 14 to system bus 142.

In a further aspect, imaging apparatus 2 can include one or more I/O interfaces 154, 156 for providing communication with external devices (e.g., a cash register server, a store server, an inventory facility server, a peer terminal, a local area network base station, a cellular base station). I/O interfaces 154, 156 can be interfaces of any combination of known computer interfaces, e.g., Ethernet (IEEE 802.3), USB, IEEE 802.11, Bluetooth, CDMA, and GSM.

One of the improvements of the present disclosure is that the contact aperture decreases a source of aberration or other degradation of the optical image by precisely centering the aperture relative to the optical lens element. Instead of relying on a stack-up of manufacturing tolerances amongst several components within an assembly, the contact aperture may be precisely located on the optical lens element in a single manufacturing sequence. De-centering of the aperture relative to the optical lens element is virtually eliminated since the aperture is integrated with the lens. Further, because the contact aperture is very thin, on the order of 0.010 inches for example, the computer models used to design the optical imaging system will have better agreement with finished product.

One advantage of the disclosed contact aperture is that the number of parts is decreased in the assembly, thereby lowering cost. The decrease in number of parts may have inconspicuous benefits as well. For example, during the development phase of a lens assembly, designers may need to isolate the cause of a particular aberration, such as image shift, image blur, vignetting, shadowing, and the like. By eliminating the aperture element in favor of a contact aperture 100, one variable is also eliminated, thereby making the troubleshooting easier.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

I claim:

1. An optical imaging apparatus for focusing an image of an encoded symbol character onto an image sensor, the optical imaging apparatus comprising:
a housing comprising a user input interface and a user output interface;
an imaging module disposed within the housing and adapted to receive a cone of bundled light rays reflected from the encoded symbol character, the imaging module comprising the image sensor having a multiple pixel image sensor array disposed on a printed circuit board;
a focus element disposed within the imaging module, the focus element adapted to form and project the encoded symbol character upon the image sensor;
a lens holding assembly disposed within the focus element, the lens holding assembly comprising a barrel housing having a distal end for receiving the cone of bundled light rays and a proximal end for projecting an apertured cone of bundled light rays onto the image sensor; and
an optical lens element disposed within an interior bore of the barrel housing, the optical lens element having a first lens surface and an opposing second lens surface, the first lens surface having a clear region and an opaque region, the opaque region formed by a contact aperture disposed on the first lens surface, the contact aperture adapted to modify a cone angle of the bundle of light rays projected on the image sensor.

2. The optical imaging apparatus of claim 1, wherein the housing is a hand-supportable housing.

3. The optical imaging apparatus of claim 1, wherein the contact aperture is applied directly to the first lens surface.

4. The optical imaging apparatus of claim 3, wherein the contact aperture comprises paint.

5. The optical imaging apparatus of claim 3, wherein the contact aperture comprises a thin film coating.

6. The optical imaging apparatus of claim 1, wherein the lens holding assembly further comprises an image formation optics assembly comprising a plurality of optical lens elements, the plurality forming a triplet, the triplet comprising a first optical lens element at the distal end of the barrel housing, a second optical lens element near the proximal end of the barrel housing, and a third optical lens element positioned between the first optical lens element and the second optical lens element.

7. The optical imaging apparatus of claim 6, wherein the contact aperture is applied to the third optical lens element.

8. The optical imaging apparatus of claim 7, wherein the contact aperture is applied to the proximal lens surface.

9. The optical imaging apparatus of claim 6, wherein the first optical lens element is biconvex lens, the second optical lens element is a positive meniscus lens having a concavity and an optical power, and the third optical lens element is a biconcave lens.

10. The optical imaging apparatus of claim 1, wherein the focus element comprises a variable position lens holder adapted for use with a moveable lens system, a base element to accept the variable position lens holder, and an actuator to provide movement of the variable position lens holder relative to the base element.

11. A method for focusing an image of encoded symbol characters onto an image sensor, the method comprising the steps of:
providing an optical imaging apparatus comprising a housing, an imaging module disposed within the housing, the imaging module including the image sensor and a lens holding assembly;
illuminating the encoded symbol characters;
focusing a cone of bundled rays reflected from the encoded symbol characters through an optical lens element onto the image sensor, the optical lens element disposed within the lens holding assembly; and
modifying a cone angle of the bundled rays projected on the image sensor by applying a contact aperture directly to lens surface of the optical lens element.

12. The method of claim 11 wherein the step of applying a contact aperture comprises the steps of:
applying a mask to a portion of the optical lens element;
coating the lens element with an opaque material; and
removing the mask.

13. The method of claim 12 wherein the coating is paint.

14. The method of claim 12 wherein the coating is a thin film deposition.

15. The method of claim 11, wherein an illumination pattern light source bank provides the illumination in the step of illuminating the encoded symbol characters.
